(19) United States
(12) Patent Application Publication
(10) Pub. No.: US 2008/0186461 A1
(43) Pub. Date: Aug. 7, 2008

(54) Liquid sealing unit and immersion photolithography apparatus having the same

(75) Inventor: In-Seop Shin, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/008,177

(22) Filed: Jan. 9, 2008

(30) Foreign Application Priority Data
Feb. 5, 2007 (KR) 10-2007-0011776

(51) Int. Cl. G03B 27/52

(52) U.S. Cl. 355/30

(57) ABSTRACT

A liquid sealing unit is provided. The liquid sealing unit includes a storage vessel for containing a liquid and having an optical nozzle hole through which light can be transmitted, and a sealing part for containing a fluid in contact with the liquid contained in the optical nozzle hole. An immersion photolithography apparatus having the liquid sealing unit is also provided. Therefore, it is possible to substantially prevent contamination of an immersion projection optical system.

### CROSS-REFERENCE TO RELATED APPLICATION

This application claims the benefit of priority under 35 U.S.C. 119 to Korean Patent Application No. 10-2007-0011776, filed Feb. 5, 2007, the disclosure of which is hereby incorporated herein by reference in its entirety.

### BACKGROUND OF THE INVENTION

1. Field of the Invention

The present invention relates to an immersion photolithography apparatus, and more particularly, to a liquid sealing unit and an immersion photolithography apparatus having the same that is capable of preventing contamination of an immersion projection optical system.

2. Description of the Related Art

In general, semiconductor devices are manufactured by various unit processes. The unit processes can include a deposition process for forming a material layer such as an insulating layer, a conductive layer, or a semiconductor layer on a semiconductor wafer, photolithography and etching processes for patterning the material layer, an ion implantation process for doping predetermined regions of the material layer or the semiconductor wafer with impurities, an annealing process for activating the impurities, a chemical mechanical polishing process for planarizing a surface of the material layer, and a cleaning process for removing contaminants remaining on a surface of the wafer passed resulting from the above processes. In particular, the photolithography process of the unit processes directly affects the integration of the semiconductor devices.

The photolithography process is performed using a photolithography apparatus having an optical system. The optical system can include a lens module, and a main light source for emitting main incident light radiated to the lens module. The main incident light is radiated onto a wafer stage through the lens module. Resolution R of the optical system can be represented as the following Formula 1.

$$R ] \frac{λ}{NA} \qquad [ Formula 1 ]$$

Here, λ represents a wavelength of the main incident light emitted from the main light source, and NA represents a numerical aperture of the lens module.

The numerical aperture NA is approximately in proportion to a diameter of the lens module, and approximately in inverse proportion to a focal distance of the lens module. The numerical aperture NA can be represented as the following Formula 2.

NA=n_{S} sin(θ) [Formula 2]

Here, n represents a refractive index of a medium between the lens module and the wafer stage, and θ represents a refractive angle, i.e., an angle between a central vertical axis of the lens module and light directed to a focal point of the lens module from the periphery of the lens module.

As can be seen from Formula 1 and Formula 2, the resolution R of the optical system can be improved by increasing the refractive angle θ of the lens module and the refractive index n of the medium between the lens module and the wafer stage.

Hereinafter, a conventional photolithography apparatus having the optical system will be described with reference to FIG. 1.

Referring to FIG. 1, the conventional photolithography apparatus 10 includes an immersion lens part for storing a liquid under a projection lens part (not shown).

The immersion lens part includes a storage vessel 12 for storing a liquid 11. The storage vessel 12 has a storage space for storing the liquid therein, upper and lower surfaces of which are exposed to the exterior. In addition, the space has a cross-section narrowing from an upper part toward a lower part thereof.

The projection lens part is disposed on the immersion lens part.

A wafer table WT is disposed under the immersion lens part. The wafer table WT includes a first mounting part on which a wafer W is mounted, and a second mounting part adjacent to the first mounting part and on which a closing disk 15 is mounted. Here, the closing disk 15 and the wafer table WT have upper surfaces disposed on substantially the same plane. While not shown, the wafer table WT can laterally moves in a straight direction.

Hereinafter, operation of the photolithography apparatus having the above constitution will be described.

A wafer W is loaded onto the first mounting part of the wafer table WT by conveying unit (not shown). The wafer W is positioned under the immersion lens part by movement of the wafer table WT. At this time, an immersion liquid is already stored in the storage vessel 12 of the immersion lens part. Then, light radiated from a light source passes through the projection lens part via a reticle (not shown), and resolution of the light is increased by the liquid 11 in the immersion lens part to be projected onto the wafer W. After the photolithography process is completed on the wafer W, the wafer W can be unloaded by movement of the wafer table WT.

At this time, an upper surface of the closing disk 15 can be disposed under the immersion lens part by movement of the wafer table WT. Then, while not shown, the closing disk 15 can be sucked to a lower surface of the storage vessel by a vacuum suction force generated through a vacuum suction hole of the immersion lens part. As a result, since the upper surface of the closing disk 15 can seal the lower surface of the storage space of the storage vessel 12 from the exterior, it is possible to prevent leakage of the liquid 11 in the storage space through its lower part.

Then, when the wafer W passed through the photolithography process is unloaded and a new wafer W is loaded onto the first mounting part, the closing disk 15 should be returned to its original position. At this time, the vacuum suction force generated through the vacuum suction hole is removed to allow the closing disk 15 to be mounted on the second mounting part. Therefore, the lower surface of the storage space of the storage vessel 12 is exposed to the exterior. Then, the new wafer W is positioned under the immersion lens part by movement of the wafer table WT, and the closing disk 15 is returned to the original position.

However, conventionally, since the lower surface of the storage space of the storage vessel 12 is closed or opened using the closing disk 15, a process time can be increased due to an operation time of the closing disk 15.

In addition, since the closing disk 15 is sucked or separated to/from the lower surface of the storage vessel 12, depending on the existence of the externally applied vacuum suction force, the closing disk 15 is repeatedly brought into contact with the lower surface of the storage vessel 12. As a result, scratches can be generated at the lower surface of the storage vessel 12 and the upper surface of the closing disk 15.

Further, contaminants, such as dusts, can be deposited into the scratches and can into the liquid 11 stored in the storage vessel. Furthermore, the contaminants can act as particles on an upper surface of the wafer W, on which a pattern is formed.

As described above, when the contaminants are deposited into the liquid 11 or on the wafer W, the contaminants can act as particles on an image refracted through the liquid 11 and projected on the wafer W, or act as contaminants of a pattern imaged on the wafer W, thereby forming an inferior pattern on the wafer W to greatly decrease yield.

### SUMMARY OF THE INVENTION

In accordance with aspects of the invention, provided are a liquid sealing unit and an immersion photolithography apparatus having the same capability of substantially preventing contaminants in the liquid in a storage vessel and defects in a pattern projected on a wafer, and improving quality of products.

Also in accordance with aspects of the invention, provided are a liquid sealing unit and an immersion photolithography apparatus having the same capability of reducing a time for sealing the liquid in a storage vessel from the exterior to reduce a photolithography process time of the wafer.

In accordance with still other aspects of the invention, provided are a liquid sealing unit and an immersion photolithography apparatus having the same capability of forming an interface with the liquid in a storage vessel to readily seal the liquid from the exterior.

In accordance with one aspect of the invention, there is provided a liquid sealing unit that includes a storage vessel configured to contain a liquid and having an optical nozzle hole formed therein configured to enable light transmission therethrough, and a sealing part configured to contain a fluid in contact with the liquid contained in the optical nozzle hole.

Here, the sealing part can have a bath configured to store a predetermined amount of fluid.

In addition, the sealing part can further include a cleaning part configured to clean the liquid. The cleaning part can include a level maintaining unit configured to maintain the liquid contained in the optical nozzle hole at a predetermined level, and a circulating unit configured to circulate the fluid stored in the bath.

The level maintaining unit can include a sensor configured to measure the level of the liquid stored in the optical nozzle hole, a fluid passage disposed in the storage vessel to be in communication with the optical nozzle hole to flow the liquid, a first pump in communication with the fluid passage, a liquid storage vessel in communication with the first pump to store the liquid, and a first controller electrically connected to the sensor to control the first pump to maintain the a measured level of the liquid substantially equal to a pre-set reference level.

Furthermore, the circulating unit can include a circulation passage formed between one side of the bath and another side of the bath, a filter installed on the circulation passage, a second pump installed on the circulation passage, and a second controller electrically connected to the second pump to control the operation of the second pump.

The first controller and the second controller can be included in a main controller.

The sealing part can be configured to seal the liquid at an interface of the optical nozzle hole by pressing the fluid against the liquid with a second pressure corresponding to a first pressure applied by the liquid, wherein the second pressure is applied by contacting the fluid with a surface of the liquid exposed at the interface.

The fluid can have substantially the same specific gravity as the liquid.

The fluid can have a specific gravity larger than that of the liquid.

The sealing part can have a bath configured to store a predetermined amount of the fluid, in which a portion of the storage vessel is immersed.

The sealing part can further include a level maintaining unit configured to maintain a level of the liquid stored in the optical nozzle hole. The level maintaining unit can include a sensor configured to measure a level of the liquid stored in the optical nozzle hole, a fluid passage disposed in the storage vessel to be in communication with the optical nozzle hole to flow the liquid, a first pump in communication with the fluid passage, a liquid storage vessel in communication with the first pump and configured to store the liquid, and a first controller electrically connected to the sensor to control the first pump to maintain a measured level of the liquid substantially equal to a pre-set reference level.

The sealing part can further include an ultrasonic cleaning device.

In accordance with another aspect of the invention, there is provide an immersion photolithography apparatus having a liquid sealing unit. The immersion photolithography apparatus includes a storage vessel configured to contain a liquid and having an optical nozzle hole formed therein configured to enable light transmission therethrough, a wafer stage configured to receive a wafer, the wafer stage movable to a lower part of the storage vessel, a sealing part configured to contain a fluid in contact with the liquid contained in the optical nozzle hole under the storage vessel, and a moving part configured to moving the sealing part to the lower part of the storage vessel.

Here, the sealing part can have a bath configured to store a predetermined amount of fluid.

The sealing part can further include a cleaning part configured to clean the liquid. The cleaning part can include a level maintaining unit configured to maintain the liquid contained in the optical nozzle hole at a predetermined level, and a circulating unit configured to circulate the fluid stored in the bath.

The level maintaining unit can include a sensor configured to measure a level of the liquid stored in the optical nozzle hole, a fluid passage disposed in the storage vessel to be in communication with the optical nozzle hole to flow the liquid, a first pump in communication with the fluid passage, a liquid storage vessel in communication with the first pump to store the liquid, and a first controller electrically connected to the sensor to control the first pump to maintain a measured level of the liquid substantially equal to a pre-set reference level. The circulating unit can include a circulation passage formed between one side of the bath and another side of the bath, a filter installed on the circulation passage, a second pump installed on the circulation passage, and a second controller electrically connected to the second pump to control the operation of the second pump.

The sealing part can be configured to seal the liquid at an interface of the optical nozzle hole by pressing the fluid against the liquid with a second pressure corresponding to a first pressure applied by the liquid. Here, the second pressure can be applied by contacting the fluid with a surface of the liquid exposed at the interface.

The fluid can have substantially the same specific gravity as the liquid.

The fluid can have a specific gravity larger than that of the liquid.

The sealing part can have a bath configured to store a predetermined amount of the fluid, in which a portion of the storage vessel can be immersed.

The sealing part can further include a level maintaining unit configured to maintain a level of the liquid stored in the optical nozzle hole. The level maintaining unit can include a sensor configured to measure the level of the liquid stored in the optical nozzle hole, a fluid passage disposed in the storage vessel to be in communication with the optical nozzle hole to flow the liquid, a first pump in communication with the fluid passage, a liquid storage vessel in communication with the first pump to store the liquid, and a first controller electrically connected to the sensor to control the first pump to maintain a measured level of the liquid substantially equal to a pre-set reference level.

The sealing part can further include an ultrasonic cleaning device.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention.

FIG. 1 is a partial cross-sectional view of a conventional immersion photolithography apparatus.

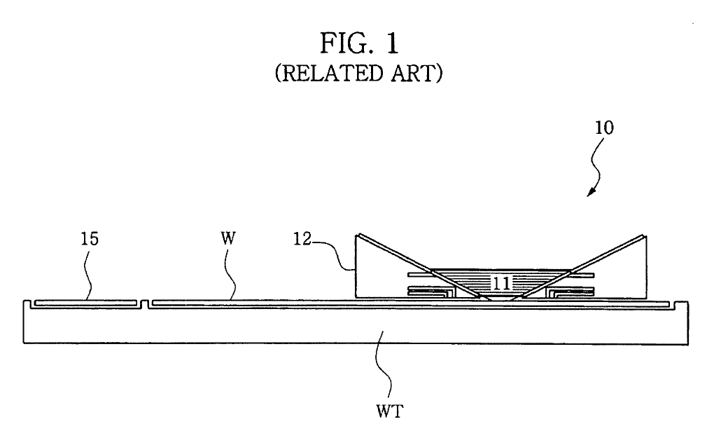

FIG. 2 is a cross-sectional view of an exemplary embodiment of a liquid sealing unit in accordance with an aspect of the present invention, before the unit is operated.

FIG. 3 is a cross-sectional view of the liquid sealing unit of FIG. 2, in accordance with an aspect of the present invention, after the unit is operated.

FIG. 4 is a block diagram of an exemplary embodiment of a liquid sealing unit in accordance with an aspect of the present invention.

FIG. 5 is a cross-sectional view of another exemplary embodiment of a liquid sealing unit in accordance with aspects of the present invention, after the unit is operated.

FIG. 6 is a cross-sectional view of an exemplary embodiment of an immersion photolithography apparatus in accordance with an aspect of the present invention, before the apparatus is operated.

FIG. 7 is a cross-sectional view of the immersion photolithography apparatus of FIG. 6, in accordance with an aspect of the present invention, after the apparatus is operated.

FIG. 8 is a block diagram of an exemplary embodiment of an immersion photolithography apparatus in accordance with an aspect of the present invention.

### DETAILED DESCRIPTION OF THE PREFERRED EMBODIMENTS

Hereinafter, a liquid sealing unit and an immersion photolithography apparatus having the same in accordance with aspects of the present invention will be described with reference to the accompanying drawings.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

First, an exemplary embodiment of a liquid sealing unit in accordance with an aspect of the present invention will now be described.

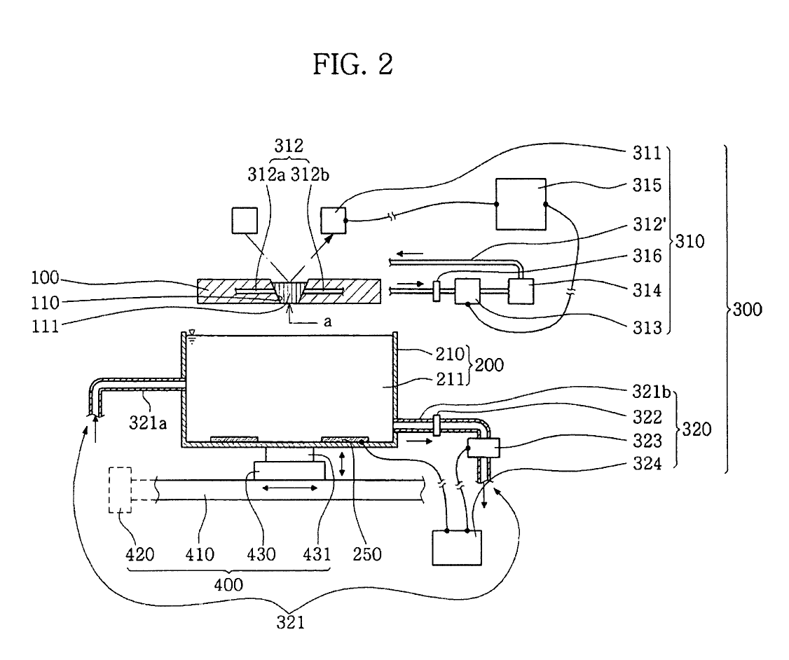

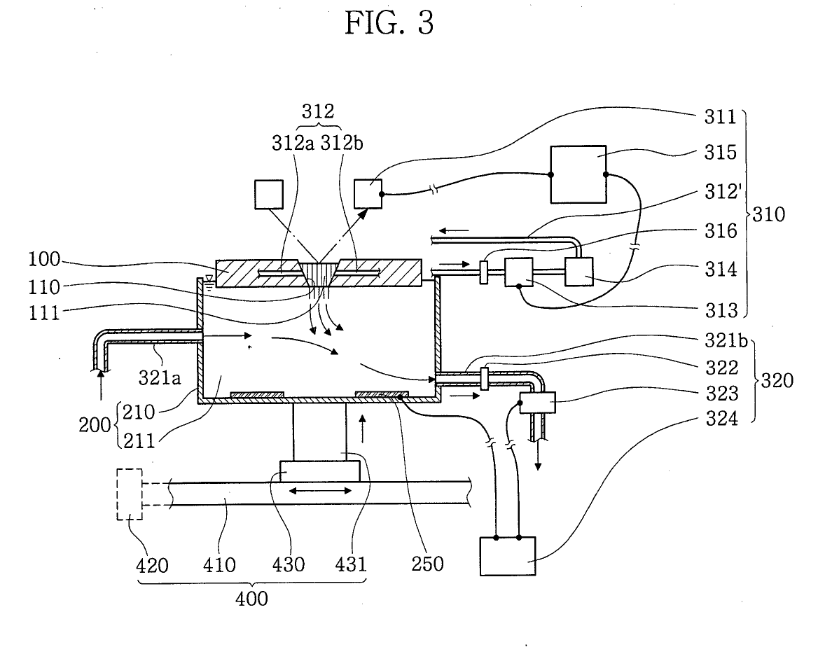

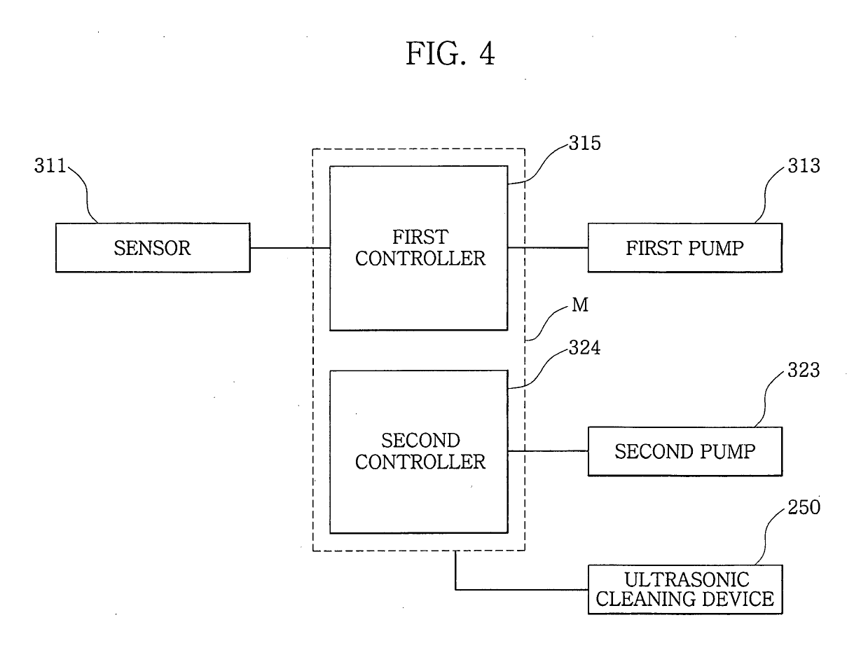

FIG. 2 is a cross-sectional view of an exemplary embodiment of a liquid sealing unit in accordance with an aspect of the present invention, before the unit is operated, FIG. 3 is a cross-sectional view of the liquid sealing unit of FIG. 2, in accordance with an aspect of the present invention, after the unit is operated, and FIG. 4 is a block diagram of an exemplary embodiment of a liquid sealing unit in accordance with an aspect of the present invention.

Referring to FIGS. 2 to 4, the embodiment of a liquid sealing unit includes a storage vessel 100 for storing a liquid, and a sealing part 200 disposed under the storage vessel 100.

The storage vessel 100 has an optical nozzle hole 110 formed at its center and through which light can be transmitted. A predetermined amount of liquid 111 is contained in the optical nozzle hole 110.

The sealing part 200 has a bath 210. A predetermined amount of fluid 211 is contained in the bath 210. The fluid 211 can be brought into contact with the liquid 111 contained in the optical nozzle hole 110. Here, the fluid can be a fluid or fluidic material, and the term fluidic material can mean a material movable in a liquefied state, e.g., a liquid.

The sealing part 200 can further include a cleaning part 300. The cleaning part 300 can clean the liquid 111 contained in the optical nozzle hole 110.

The cleaning part 300 can include level maintaining unit 310 configured for maintaining the liquid 111 contained in the optical nozzle hole 110 at a pre-set level, and a circulating unit 320 configured for circulating the fluid 211 stored in the bath 210.

Specifically, the level maintaining unit 310 can include a sensor 311 configured to measure a level of the liquid 111 stored in the optical nozzle hole 110, a fluid passage 312 disposed in the storage vessel 100 to be in communication with the optical nozzle hole 110 and to enable flow of the liquid 111 thereto, a first pump 313 in communication with the fluid passage 312 through a tube 312′, a liquid storage vessel 314 in communication with the first pump 313 through the tube 312′ and configured to store the liquid 111, and a first controller 315 electrically connected to the sensor 311 and configured to control the first pump 313 such that a reference level is pre-set and the measured level is maintained equal to the reference level.

The circulating unit 320 can include a circulation passage 321 for enabling communication between one side of the bath 210 and the other side of the bath 210, wherein the circulation passage 321 can include a first circulation passage 321a and a second circulation passage 321b. A filter 322 is installed on the second circulation passage 321b, as is a second pump 323. And a second controller 324 is electrically connected to and configured to control the operation of the second pump 323 and, thereby, circulation of the fluid 211 through the circulation passage 321.

The first controller 315 and the second controller 324 can be included in a main controller M (see FIG. 4).

Meanwhile, the bath 210 is connected to the moving part 400. The moving part 400 can include a straight rail 410 connected to the bath 210, a motor 420 connected to the straight rail 410 to reciprocate the straight rail 410, and a cylinder 430 disposed on the straight rail 410 to vertically move the bath 210. The cylinder 430 includes a lift shaft 431, which can be connected to the bath 210 or connected to the straight rail 410.

In the meantime, the sealing part 200 can further include an ultrasonic cleaning device 250. The ultrasonic cleaning device 250 functions to remove particles existing in the fluid 211 contained in the bath 210. The ultrasonic cleaning device 250 is electrically connected to the main controller M and configured to be driven depending on a signal of the main controller M.

Hereinafter, operation of the liquid sealing unit in accordance with this exemplary embodiment will be described.

Referring to FIGS. 2 to 4, a predetermined amount of liquid 111 is contained in the optical nozzle hole 110 of the storage vessel 100.

The first controller 315 operates the first pump 313. The first pump 313 pumps the liquid 111 stored in the liquid storage vessel 314 to supply the liquid 111 to the optical nozzle hole 110 through the first liquid passage 312a. The optical nozzle hole 110 can be filled with the liquid 111. In addition, when the liquid 111 is filled in the optical nozzle hole 110 such that the second liquid passage 312b is immersed, the liquid 111 can flow to the liquid storage vessel 314 through the second liquid passage 312b. Next, when a predetermined amount of liquid 111 is contained in the optical nozzle hole 110, the first controller 315 can stop the operation of the first pump 313.

Therefore, the predetermined amount of liquid 111 can be maintained in the optical nozzle hole 110.

Meanwhile, a predetermined amount of fluid 211 can be contained in the bath 210, which can be spaced apart from the storage vessel 100 by a predetermined distance.

Then, the bath 210 can move to a lower part of the storage vessel 100 by the moving part 400. That is, the motor 420 drives the straight rail 410 to move the bath installed on the straight rail 410 under the storage vessel 100. In addition, the bath 210 can be raised to a predetermined height by a lift operation of the cylinder 430. That is, the lift shaft 431 of the cylinder 430 can be connected to the bath 210 to raise the bath 210, or can be connected to the straight rail 410 to raise the straight rail 410.

As described above, when the bath 210 is raised to a predetermined height, the storage vessel 100 can be partially immersed in the fluid 211 contained in the bath 210.

Specifically, the liquid 111 contained in the optical nozzle hole 110 of the storage vessel 100 can be in contact with the fluid 211 contained in the bath 210 through an exposed surface formed at a lower part of the optical nozzle hole 110. Here, the exposed surface can be an interface “a”, in which the liquid 111 contained in the optical nozzle hole 110 is in contact with the fluid 211 stored in the bath 210.

In this state, the cleaning part 300 in accordance with this embodiment can function to remove particles, which can be formed around the optical nozzle hole 110, as well as to clean the liquid 111 contained in the optical nozzle hole 110.

An embodiment of an operation of the cleaning part 300 will now be described below in detail.

The second controller 324 operates the second pump 323. The second pump 323 pumps the fluid 211 stored in the bath 210 to introduce the fluid 211 into the first circulation passage 321a. The fluid 211 introduced into the first circulation passage 321a passes through the filter 322. The filter 322 can filter particles, which can exist in the fluid 211. The fluid 211 passed through the filter 322 can be discharged again to the bath 210 through the second circulation passage 321b.

Therefore, the fluid 211 stored in the bath 210 can be circulated by the second pump 323. In addition, since the second controller 324 can adjust pumping capability of the second pump 323, a circulation speed of the fluid 211 can be in proportion to the pumping capability of the second pump 323.

At this time, the liquid 111 contained in the optical nozzle hole 110 in contact with the fluid 211 can be drawn into the fluid 211 circulated in the bath 210. As a result, the liquid 111 can be mixed with the fluid 211 and circulated therewith.

Therefore, when particles exist in the liquid 111, the particles can be contained in the fluid 211 and circulated therewith to be filtered by the filter 322. In addition, when particles are formed under the storage vessel 100, i.e., around the optical nozzle hole 110, the particles can be contained in the fluid 211 and circulated therewith to be filtered by the filter 322.

Meanwhile, the liquid 111 contained in the optical nozzle hole 110 can be maintained at a certain level by the level maintaining unit 310.

Specifically, the sensor 311 measures the level of the liquid 111 contained in the optical nozzle hole 110 and transmits the measured level to the first controller 315. The first controller 315 operates the first pump 313 to circulate the liquid 111 through the first and second fluid passages 312a and 312b. In addition, the first controller 315 can control the first pump 313 such that the measured level is equal to a pre-set reference level. Therefore, it is possible to maintain the liquid 111 contained in the optical nozzle hole 110 at a certain level. That is, a certain amount of liquid 111 can be contained in the optical nozzle hole 110.

A filter 316 can be further installed at the first and second fluid passages 312a and 312b to filter particles, which can be contained in the liquid 111. The filter 316 can be the same as the filter 322 installed at the first circulation passage 321a.

In addition, since the sealing part 200 can further include an ultrasonic cleaning device 250, it is possible to more readily remove the particles contained in the fluid 211 and the liquid 111 circulated as described above. The ultrasonic cleaning device 250 is electrically connected to the main controller M and driven by a signal from the main controller M.

Therefore, the particles, which can be contained in the fluid 211 and the liquid 111, are circulated as described above to be filtered by the filters 316 and 322 and readily removed by the ultrasonic cleaning device 250 operating in the bath 210.

When the above operation is completed, the second controller 324 stops the operation of the second pump 323. Then, the moving part 400 returns the bath 210 to its original position. At this time, the liquid 111 contained in the optical nozzle hole 110 can be maintained at a certain level by the level maintaining unit 310.

Hereinafter, another exemplary embodiment of a liquid sealing unit in accordance with aspects of the present invention will be described.

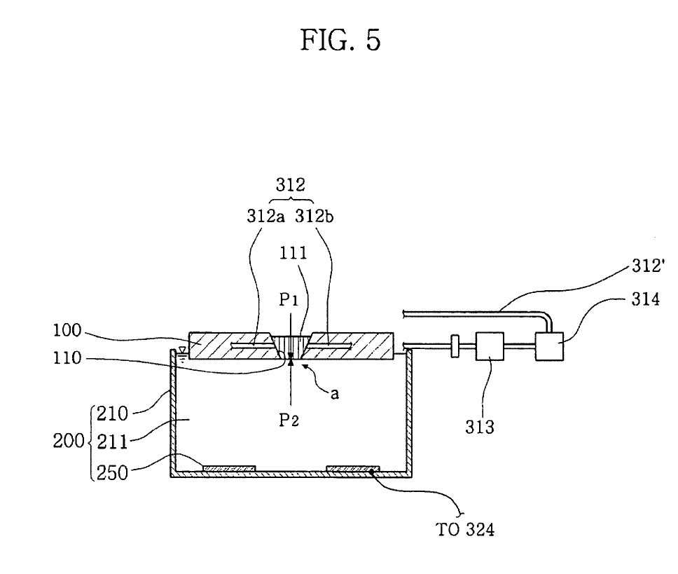

FIG. 5 is a cross-sectional view of the other exemplary embodiment of a liquid sealing unit in accordance with aspects of the present invention, after the unit is operated.

Referring to FIG. 5, the liquid sealing unit includes a storage vessel 100, and a sealing part 200, as in the embodiment of FIGS. 2 and 3.

The storage vessel 100 can, for example, have the same constitution as the embodiment shown in FIGS. 2 to 4.

The sealing part 200 can have the fluid 211 for sealing the liquid 111 at the interface “a” of the optical nozzle hole 110 by applying a second pressure P2 corresponding to a first pressure P1 due to the liquid 111.

The second pressure P2 can be applied by contacting the fluid 211 with a surface of the liquid 111 exposed to the interface “a”. Here, the fluid 211 can have the same specific gravity as the liquid 111. In other embodiments, the fluid 211 can have a specific gravity larger than the liquid 111.

Here, the sealing part 200 has the bath 210 for storing a certain amount of fluid 211, in which a portion of the storage vessel 100 is immersed.

In addition, the sealing part 200 can further include the level maintaining unit 310 configured for uniformly maintaining the level of the liquid 111 stored in the optical nozzle hole 110. The level maintaining unit 310 can have the same constitution as that shown in the embodiment shown in FIGS. 2 to 4, so its description will not be repeated.

In addition, the sealing part 200 can further include the ultrasonic cleaning device 250. The ultrasonic cleaning device 250 functions to remove particles contained in the fluid 211 in the bath 210. The ultrasonic cleaning device 250 is electrically connected to main controller M, and is driven by a signal from the main controller M.

Hereinafter, the operation of the liquid sealing unit in accordance with this exemplary embodiment will be described.

Referring to FIG. 5, a certain amount of liquid 111 is contained in the optical nozzle hole 110 of the storage vessel 100. The liquid 111 can be supplied in the same manner as the embodiment of FIGS. 2 to 4. As described above, the liquid 111 contained in the optical nozzle hole 110 has a certain weight. This can be applied as a predetermined magnitude of first pressure P1 at the interface “a” of the optical nozzle hole 110.

In this state, the bath 210 can be moved under the storage vessel 100 and raised upward to the bath 210 by the moving part 400.

Therefore, a lower part of the storage vessel 100 can be immersed in the fluid 211 contained in the bath 210, and the liquid 111 contained in the optical nozzle hole 110 can be brought into contact with the fluid 211. At this time, the fluid 211 has a second pressure P2 having the same magnitude as the first pressure P1 at the interface “a” of the optical nozzle hole 110. The second pressure P2 can be applied in a direction opposite to the first pressure P1.

As a result, since a point of application of the first pressure P1 and the second pressure P2 is formed at the interface “a” of the optical nozzle hole 110, the fluid 211 can function to cover the liquid 111 at the interface “a” of the optical nozzle hole 110.

Here, the liquid 111 can have the same specific gravity as the fluid 211. In other embodiments, the fluid 211 can have a specific gravity larger than that of the liquid 111. In either case, the fluid 211 functions to readily seal the liquid 111 from the exterior at the interface “a” of the optical nozzle hole 110.

In this state, since the sealing part 200 further includes an ultrasonic cleaning device 250, it is possible to more readily remove the particles contained in the lower surface of the storage vessel 100 in surface contact with the fluid 211, around the optical nozzle hole 110, and in the exposed surface of the liquid 111 (e.g., a surface of the liquid 111 positioned at the interface “a”). The ultrasonic cleaning device 250 is electrically connected to the main controller M to be driven by a signal from the main controller M.

Then, the bath 210 can be separated from the storage vessel 100 by the moving part 400.

At this time, the liquid 111 contained in the optical nozzle hole 110 can be partially drawn into the bath 210 with the fluid 211. However, since the amount of liquid evacuated from the optical nozzle hole 110 is additionally supplied into the optical nozzle hole 110 by the level maintaining unit 310, it is possible to contain a certain amount of liquid 111 in the optical nozzle hole 110 to maintain the reference level.

Hereinafter, a photolithography apparatus having a liquid sealing unit in accordance with aspects of the present invention will be described.

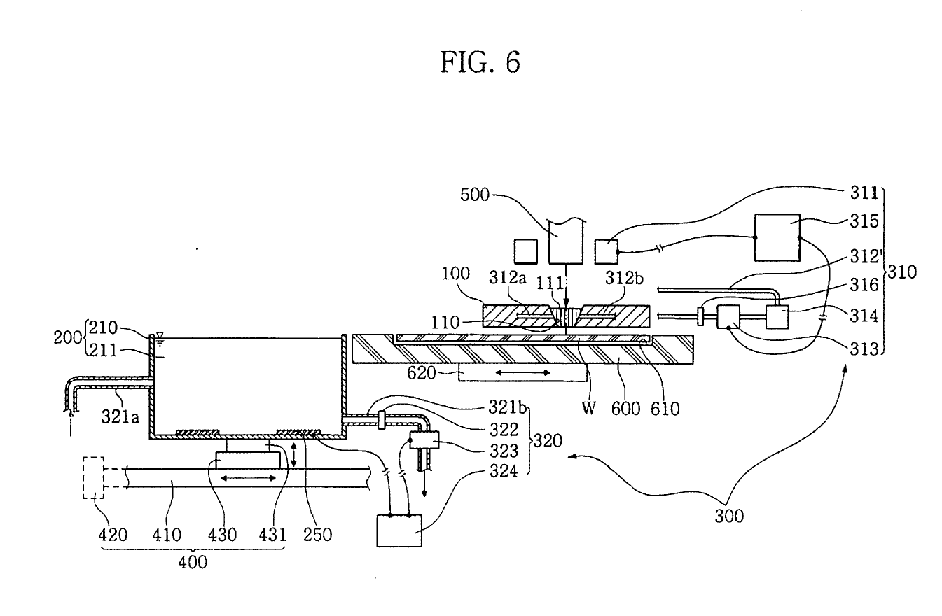

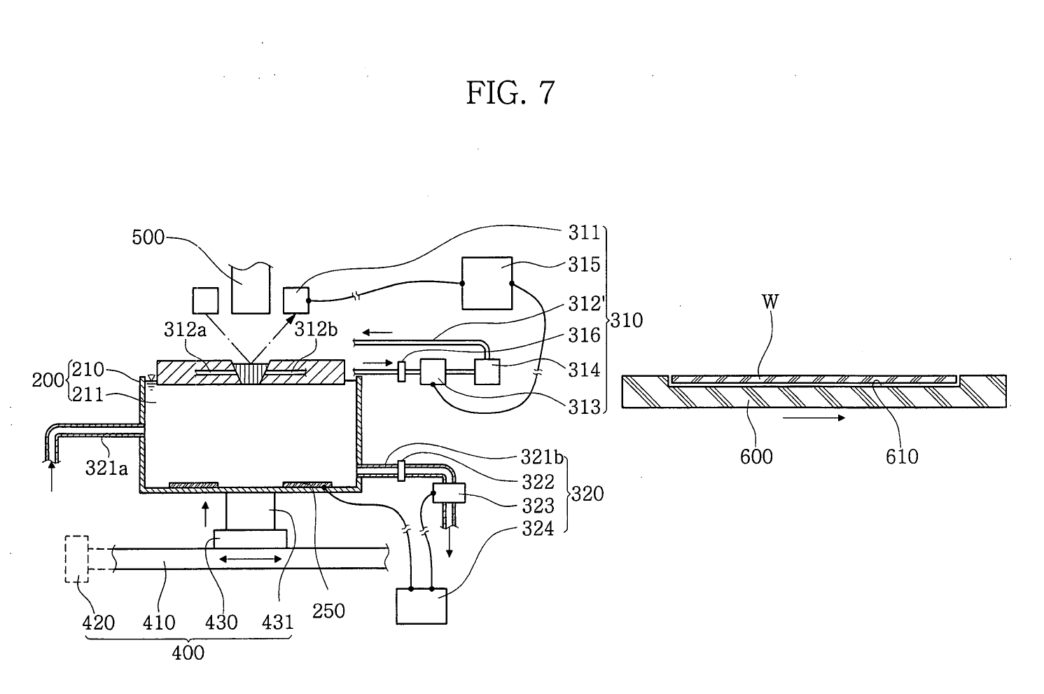

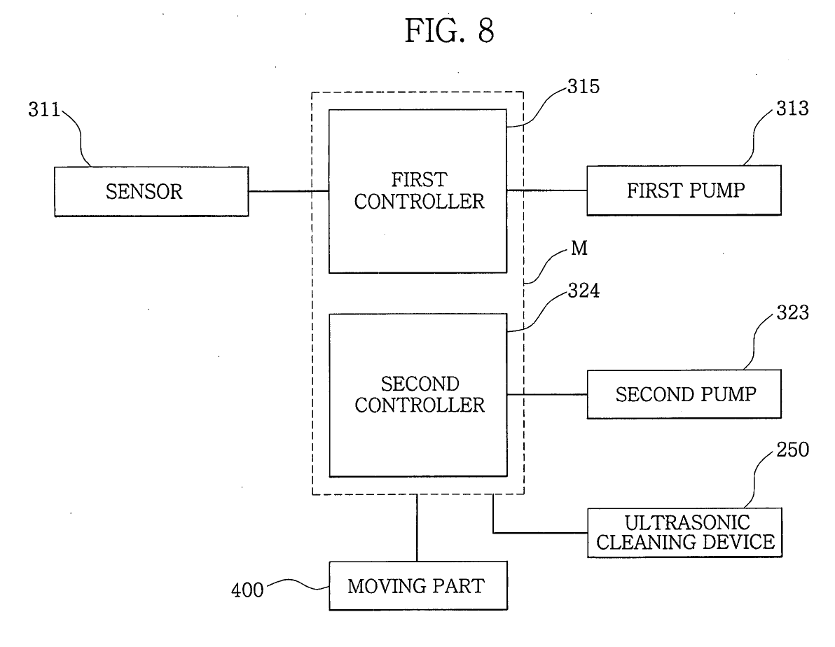

FIG. 6 is a cross-sectional view of an embodiment of an immersion photolithography apparatus in accordance with aspects of the present invention, before the apparatus is operated, FIG. 7 is a cross-sectional view of the immersion photolithography apparatus of FIG. 6 after the apparatus is operated, and FIG. 8 is a block diagram of an immersion photolithography apparatus in accordance with an exemplary embodiment of the present invention.

Referring to FIGS. 6 to 8, the embodiment of an immersion photolithography apparatus includes a projection optical system 500 configured for projecting light radiated to the exterior, storage vessel 100 for containing liquid 111 and having optical nozzle hole 110 through which the projected light transmits the liquid 111 to be refracted at a certain refractive index, a wafer stage 600, on which a wafer W is mounted, movable under the storage vessel 100, sealing part 200 for containing fluid 211 in contact with the liquid 111 contained in the optical nozzle hole 110 at a lower part of the storage vessel 100, and moving part 400 for moving the sealing part 200 to a lower part of the storage vessel 100.

The wafer stage 600 can be connected to moving unit 620, such as a rail. The wafer stage 600 is straightly movable by the moving unit 620. The moving unit 620 can be driven by an electric signal of the main controller M, e.g., comprising first and second controllers 315, 324 (see FIG. 8).

The storage vessel 100 has the optical nozzle hole 110 disposed at its center and through which light transmits. A certain amount of liquid 111 is contained in the optical nozzle hole 110.

The sealing part 200 includes bath 210. A certain amount of fluid 211 is contained in the bath 210. The fluid 211 can be brought into contact with the liquid 111 contained in the optical nozzle hole 110.

The sealing part 200 can further include cleaning part 300. The cleaning part 300 can clean the liquid 111 contained in the optical nozzle hole 110.

The cleaning part 300 can include level maintaining unit 310 configured for maintaining the liquid 111 contained in the optical nozzle hole 110 at a predetermined level, and circulating unit 320 configured for circulating the fluid 211 stored in the bath 210.

Specifically, the level maintaining unit 310 can be substantially the same as that shown in FIG. 2, and include sensor 311 configured for measuring the level of the liquid 111 stored in the optical nozzle hole 110, fluid passage 312 disposed in the storage vessel 100 to be in communication with the optical nozzle hole 110 and configured for flowing the liquid 111 therethrough, first pump 313 in communication with the fluid passage 312 through tube 312′, liquid storage vessel 314 in communication with the first pump 313 through the tube 312′ and storing the liquid 111, and first controller 315 electrically connected to the sensor 311 and controlling the first pump 313 such that a reference level is pre-set and the measured level is equal to the reference level.

The circulating unit 320 can include a circulation passage 321 for communicating one side of the bath 210 with the other side of the bath 210, a filter 322 installed on the circulation passage 321, a second pump 323 installed on the circulation passage 321, and a second controller 324 electrically connected to the second pump 323 and controlling the operation of the second pump 323.

The first controller 315 and the second controller 324 can be included in main controller M.

Meanwhile, the bath 210 is connected to the moving part 400.

The moving part 400 can include straight rail 410 connected to the bath 210, motor 420 connected to the straight rail 410 to reciprocate the straight rail 410, and cylinder 430 disposed on the straight rail 410 to vertically move the bath 210, also as in FIG. 2. The cylinder 430 includes lift shaft 431, which can be connected to the bath 210 or connected to the straight rail 410.

The sealing part 200 can further include ultrasonic cleaning device 250. The ultrasonic cleaning device 250 functions to remove particles existing in the fluid 211 contained in the bath 210. The ultrasonic cleaning device 250 is electrically connected to the main controller M to be driven depending on a signal of the main controller M.

Hereinafter, the operation of the liquid sealing unit in accordance with this exemplary embodiment will be described.

Referring to FIGS. 6 to 8, first, a predetermined amount of liquid 111 is contained in the optical nozzle hole 110 of the storage vessel 100.

The first controller 315 operates the first pump 313. The first pump 313 pumps the liquid 111 stored in the liquid storage vessel 314 to supply the liquid 111 to the optical nozzle hole 110 through the first liquid passage 312a. The optical nozzle hole 110 can be filled with the liquid 111. In addition, when the liquid 111 is filled in the optical nozzle hole 110 such that the second liquid passage 312b is immersed, the liquid 111 can flow to the liquid storage vessel 314 through the second liquid passage 312b. Next, when a predetermined amount of liquid 111 is contained in the optical nozzle hole 110, the first controller 315 can stop the operation of the first pump 313.

Therefore, the predetermined amount of liquid 111 can be maintained in the optical nozzle hole 110.

In addition, a predetermined amount of fluid 211 can be contained in the bath 210 spaced apart from the storage vessel 100 by a predetermined distance.

As described above, the liquid 111 is prepared in the optical nozzle hole 110 of the storage vessel 100, and the fluid 211 is prepared in the bath 210.

Meanwhile, wafer W is loaded onto a mounting part 610 of the wafer stage 600 by a conveying device (not shown). The wafer stage 600 is moved within a plane, in this embodiment, by the moving unit 620. Therefore, the wafer W can be disposed under the storage vessel 100. At this time, an upper surface of the wafer W is spaced apart from a lower surface of the storage vessel 100 by a predetermined gap. The storage vessel 100 can further include an air supply unit (not shown) configured for isolating the wafer W from around the optical nozzle hole 110 at the gap using the air.

In this state, light radiated from a light source (not shown) passes through a reticle (not shown), and the passed light is transmitted to the projection optical system 500. At this time, the light transmitted to the projection optical system 500 includes an image of a circuit pattern.

In addition, the light passes through the liquid 111 with a certain refractive index, and the light having a specific wavelength passes through the optical nozzle hole 110 to be transmitted onto the wafer W. Therefore, the light passed through the optical nozzle hole 110 forms an image of the circuit pattern on the wafer W.

After completion of the photolithography process on the wafer W, the wafer W is unloaded from the mounting part 610, and a new wafer W, which will be subjected to the photolithography process, should be mounted on the mounting part 610.

The wafer stage 600 can be moved by the moving unit 620 to unload the wafer W passed through the process. Therefore, the mounting part 610 can be separated from a lower region of the storage vessel 100.

At this time, the bath 210 can be disposed under the storage vessel 100. This will be described below in detail.

The bath 210 can be moved under the storage vessel 100 by the moving part 400. That is, the motor 420 drives the straight rail 410, and the bath 210 installed at the straight rail 410 is disposed under the storage vessel 100. In addition, the bath 210 can be raised to a certain height by a lift operation of the cylinder 430. That is, the lift shaft 431 of the cylinder 430 can be connected to the bath 210 to raise the bath 210, or can be connected to the straight rail 410 to raise the straight rail 410.

As described above, when the bath 210 is raised to a certain height, a lower part of the storage vessel 100 can be partially immersed in the fluid 211 contained in the bath 210.

That is, the liquid 111 contained in the optical nozzle hole 110 of the storage vessel 100 can be in contact with the fluid 211 contained in the bath 210 through the interface “a” formed at a lower part of the optical nozzle hole 110.

In this state, the cleaning part 300 in accordance with aspects the present invention can remove particles, which can be generated around the optical nozzle hole 110, as well as clean the liquid 111 contained in the optical nozzle hole 110.

The operation of the cleaning part 300 will be described below in detail.

The second controller 324 operates the second pump 323. The second pump 323 pumps the fluid 211 stored in the bath 210 to introduce the fluid 211 into first circulation passage 321a. The fluid 211 introduced into the first circulation passage 321a passes through the filter 322. The filter 322 can filter particles, which can exist in the fluid 211. The fluid 211 passed through the filter 322 can be discharged again to the bath 210 through a second circulation passage 321b. Therefore, the fluid 211 stored in the bath 210 can be circulated by the second pump 323. In addition, since the second controller 324 can adjust pumping capability of the second pump 323, a circulation speed of the fluid 211 can be in proportion to the pumping capability of the second pump 323.

At this time, the liquid 111 contained in the optical nozzle hole 110 in contact with the fluid 211 can be drawn into the fluid 211 circulated in the bath 210. As a result, the liquid 111 can be contained in the fluid 211 to be circulated therewith.

Therefore, when particles exist in the liquid 111, the particles can be mixed in with the fluid 211 and circulated therewith to be filtered by the filter 322. In addition, when particles are generated under the storage vessel 100, i.e., around the optical nozzle hole 110, the particles can be contained in the fluid 211 and circulated therewith to be filtered by the filter 322.

Meanwhile, the liquid 111 contained in the optical nozzle hole 110 can be maintained at a certain level by the level maintaining unit 310.

Specifically, the sensor 311 measures the level of the liquid 111 contained in the optical nozzle hole 110 to transmit the measured level to the first controller 315. The first controller 315 operates the first pump 313 to circulate the liquid 111 through the first and second fluid passages 312a and 312b. In addition, the first controller 315 can control the first pump 313 such that the measured level is equal to a pre-set reference level. Therefore, it is possible to maintain the liquid 111 contained in the optical nozzle hole 110 at a certain level. That is, a certain amount of liquid 111 can be contained in the optical nozzle hole 110.

Of course, a filter 316 can be further installed at the first and second fluid passages 312a and 312b to filter particles, which can be contained in the liquid 111. The filter 316 can be the same as the filter 322 installed at a first circulation passage 321a.

In addition, since the sealing part 200 can further include an ultrasonic cleaning device 250, it is possible to more readily remove the particles contained in the fluid 211 and the liquid 111 circulated as described above. The ultrasonic cleaning device 250 is electrically connected to the main controller M to be driven by a signal from the main controller M.

Therefore, the particles, which can be contained in the fluid 211 and the liquid 111, are circulated as described above to be filtered by the filters 316 and 322 and readily removed by the ultrasonic cleaning device 250 operating in the bath 210.

When the above operation is completed, the second controller 324 stops the operation of the second pump 323. Then, the moving part 400 returns the bath 210 to its original position. At this time, the liquid 111 contained in the optical nozzle hole 110 can be maintained at a certain level by the level maintaining unit 310.

Next, when the bath 210 is returned to its original position, the wafer stage 600 can also be returned to its original position. At this time, a new wafer, which will be subjected to a photolithography process, is mounted on the mounting part 610 of the wafer stage 600.

Therefore, after performing the photolithography process of the wafer W as described above, the above processes can be repeated.

As can be seen from the foregoing, in accordance with aspects of the present invention, there are provided a liquid sealing unit and a photolithography apparatus having the same capability of cleaning a liquid for providing a certain refractive index to projection light and particles which can be generated from a storage vessel for containing the liquid, and sealing the liquid.

Since the liquid contained in the storage vessel is in contact with a forcedly circulated fluid and contained into the fluid to be forcedly circulated therewith, it is possible to readily discharge the particles, which can be contained in the liquid, to the exterior.

In addition, by contacting the fluid with a lower surface of the storage vessel, it is possible to discharge particles, which can be generated from the lower surface of the storage vessel, using the fluid flow forcedly circulated therethrough.

Further, it is possible to more readily remove the particles by installing an ultrasonic cleaning device in the bath.

Therefore, it is possible to prevent contaminants from being contained in the liquid stored in the storage vessel, and prevent generation of defects from a pattern projecting onto the wafer, thereby improving quality of products.

Furthermore, the fluid forms an interface with the liquid stored in the storage vessel to cover the liquid. When a wafer is loaded or unloaded to/from a wafer stage, it is possible to reduce a time for closing the liquid in the storage vessel from the exterior, and thus reduce a photolithography process time of the wafer.

Although exemplary embodiments in accordance with aspects of the present invention have been described, it will be understood by those skilled in the art that a variety of modifications and variations can be made without departing from the spirit or scope of the present invention defined in the appended claims, and their equivalents.

What is claimed is:

1. A liquid sealing unit comprising:
a storage vessel configured to contain a liquid and having an optical nozzle hole formed therein configured to enable light transmission therethrough; and
a sealing part configured to contain a fluid in contact with the liquid contained in the optical nozzle hole.

2. The liquid sealing unit according to claim 1, wherein the sealing part includes a bath configured to store a predetermined amount of fluid.

3. The liquid sealing unit according to claim 2, wherein the sealing part further comprises:
a cleaning part configured to clean the liquid, the cleaning part comprising a level maintaining unit configured to maintain the liquid contained in the optical nozzle hole at a predetermined level and a circulating unit configured to circulate the fluid stored in the bath.

4. The liquid sealing unit according to claim 3, wherein:
the level maintaining unit comprises:
a sensor configured to measure a level of the liquid stored in the optical nozzle hole,
a fluid passage disposed in the storage vessel to be in communication with the optical nozzle hole to flow the liquid,
a first pump in communication with the fluid passage,
a liquid storage vessel in communication with the first pump to store the liquid, and
a first controller electrically connected to the sensor to control the first pump to maintain a measured level of the liquid substantially equal to a pre-set reference level, and
the circulating unit comprises:
a circulation passage formed between one side of the bath and another side of the bath,
a filter installed on the circulation passage,
a second pump installed on the circulation passage, and
a second controller electrically connected to the second pump to control the operation of the second pump.

5. The liquid sealing unit according to claim 1, wherein the sealing part is configured to seal the liquid at an interface of the optical nozzle hole by pressing the fluid against the liquid with a second pressure corresponding to a first pressure applied by the liquid, the second pressure being applied by contacting the fluid with a surface of the liquid exposed at the interface.

6. The liquid sealing unit according to claim 5, wherein the fluid has substantially the same specific gravity as the liquid.

7. The liquid sealing unit according to claim 5, wherein the fluid has a specific gravity larger than that of the liquid.

8. The liquid sealing unit according to claim 5, wherein the sealing part has a bath configured to store a predetermined amount of the fluid, in which a portion of the storage vessel is immersed.

9. The liquid sealing unit according to claim 5, wherein the sealing part further comprises level a maintaining unit configured to maintain a level of the liquid stored in the optical nozzle hole, the level maintaining unit comprising:
a sensor configured to measure the level of the liquid stored in the optical nozzle hole,
a fluid passage disposed in the storage vessel to be in communication with the optical nozzle hole to flow the liquid,
a first pump in communication with the fluid passage,
a liquid storage vessel in communication with the first pump and configured to store the liquid, and
a first controller electrically connected to the sensor to control the first pump to maintain a measured level of the liquid substantially equal to a pre-set reference level.

10. The liquid sealing unit according to claim 1, wherein the sealing part further comprises an ultrasonic cleaning device.

11. An immersion photolithography apparatus having a liquid sealing unit, comprising:
a storage vessel configured to contain a liquid and having an optical nozzle hole formed therein configured to enable light transmission therethrough;
a wafer stage configured to receive a wafer, the wafer stage movable to a lower part of the storage vessel;
a sealing part configured to contain a fluid in contact with the liquid contained in the optical nozzle hole under the storage vessel; and
a moving part configured to move the sealing part to the lower part of the storage vessel.

12. The immersion photolithography apparatus according to claim 11, wherein the sealing part has a bath configured to store a predetermined amount of the fluid.

13. The immersion photolithography apparatus according to claim 12, wherein the sealing part further comprises:
a cleaning part configured to clean the liquid, the cleaning part comprising a level maintaining unit configured to maintain the liquid contained in the optical nozzle hole at a predetermined level and a circulating unit configured to circulate the fluid stored in the bath.

14. The immersion photolithography apparatus according to claim 13, wherein:
the level maintaining unit comprises:
a sensor configured to measure a level of the liquid stored in the optical nozzle hole,
a fluid passage disposed in the storage vessel to be in communication with the optical nozzle hole to flow the liquid,
a first pump in communication with the fluid passage,
a liquid storage vessel in communication with the first pump to store the liquid, and
a first controller electrically connected to the sensor to control the first pump to maintain a measured level of the liquid substantially equal to a pre-set reference level, and
the circulating unit comprises:
a circulation passage formed between one side of the bath and another side of the bath,
a filter installed on the circulation passage,
a second pump installed on the circulation passage, and
a second controller electrically connected to the second pump to control the operation of the second pump.

15. The immersion photolithography apparatus according to claim 11, wherein the sealing part is configured to seal the liquid at an interface of the optical nozzle hole by pressing the fluid against the liquid with a second pressure corresponding to a first pressure applied by the liquid, the second pressure being applied by contacting the fluid with a surface of the liquid exposed at the interface.

16. The immersion photolithography apparatus according to claim 15, wherein the fluid has substantially the same specific gravity as the liquid.

17. The immersion photolithography apparatus according to claim 15, wherein the fluid has a specific gravity larger than that of the liquid.

18. The immersion photolithography apparatus according to claim 15, wherein the sealing part has a bath configured to store a predetermined amount of the fluid, in which a portion of the storage vessel is immersed.

19. The immersion photolithography apparatus according to claim 15, wherein the sealing part further comprises a level maintaining unit configured to maintain a level of the liquid stored in the optical nozzle hole, the level maintaining unit comprising:
a sensor configured to measure the level of the liquid stored in the optical nozzle hole,
a fluid passage disposed in the storage vessel to be in communication with the optical nozzle hole to flow the liquid,
a first pump in communication with the fluid passage,
a liquid storage vessel in communication with the first pump to store the liquid, and
a first controller electrically connected to the sensor to control the first pump to maintain a measured level of the liquid substantially equal to a pre-set reference level.

20. The immersion photolithography apparatus according to claim 11, wherein the sealing part further comprises an ultrasonic cleaning device.
